(19) United States
(12) Patent Application Publication
(10) Pub. No.: US 2025/0285541 A1
(43) Pub. Date: Sep. 11, 2025

(54) DISPLAY CONTROL DEVICE, DISPLAY CONTROL METHOD, AND STORAGE MEDIUM

(71) Applicant: TOYOTA JIDOSHA KABUSHIKI KAISHA, Toyota-shi (JP)

(72) Inventor: Miki TSUJINO, Nagakute-shi (JP)

(73) Assignee: TOYOTA JIDOSHA KABUSHIKI KAISHA, Toyota-shi (JP)

(21) Appl. No.: 19/061,398

(22) Filed: Feb. 24, 2025

(30) Foreign Application Priority Data
Mar. 7, 2024 (JP) 2024-035308

(51) Int. Cl. G08G 1/16; G09G 3/00

(52) U.S. Cl. CPC G08G 1/166; G09G 3/001; G09G 2320/0666; G09G 2380/10

(57) ABSTRACT

A display control device includes a display control unit that is configured to: display, on a display unit provided in a vehicle, a host vehicle image representing the vehicle and a preceding vehicle image representing a preceding vehicle and arranged in accordance with a relative positional relationship between the vehicle and the preceding vehicle; and display a first side on the display unit in a manner different from a second side on the display unit, the first side being a side of the host vehicle image with respect to a set following position that is set based on a following distance setting in a preceding vehicle following function, and the second side being an opposite side of the first side with respect to the set following position.

### CROSS-REFERENCE TO RELATED APPLICATION

This application is based on and claims priority under 35 USC 119 from Japanese Patent Application No. 2024-035308 filed on Mar. 7, 2024, the disclosure of which is incorporated by reference herein.

### BACKGROUND

### Technical Field

The technology of the disclosure relates to a display control device, a display control method, and a non-transitory storage medium and a program product storing a display control program.

### Related Art

Japanese Patent No. 7,043,965 discloses that a proper following distance in adaptive cruise control refers to a range where a predetermined distance is added to the front and back of a set following distance in consideration of control stability, and that an indicator indicating the proper following distance is displayed only when a preceding vehicle is in the range of this proper following distance and is hidden when the preceding vehicle is outside this range.

In Japanese Patent No. 7,043,965, only the indicator indicating the proper following distance is displayed forward of the host vehicle and in the direction in which the preceding vehicle is displayed, making it difficult for the user to intuitively understand the following distance that has been set.

### SUMMARY

The present disclosure provides a display control device with which in a preceding vehicle following function an occupant (user) may intuitively understand from visual information the following distance that has been set, a display control method, and a non-transitory storage medium and a program product storing a display control program.

A first aspect of the present disclosure is a display control device including a display control unit that is configured to: display, on a display unit provided in a vehicle, a host vehicle image representing the vehicle and a preceding vehicle image representing a preceding vehicle and arranged in accordance with a relative positional relationship between the vehicle and the preceding vehicle; and display a first side on the display unit in a manner different from a second side on the display unit, the first side being a side of the host vehicle image with respect to a set following position that is set based on a following distance setting in a preceding vehicle following function, and the second side being an opposite side of the first side with respect to the set following position.

According to the first aspect, by displaying the host vehicle image side (i.e., the first side) with respect to the set following position in a manner different from the opposite side (i.e., the second side) of the host vehicle image side with respect to the set following position, in the preceding vehicle following function the occupant may intuitively understand from visual information the following distance that has been set (hereinafter also called “the set following distance”).

A second aspect of the present disclosure is the first aspect, wherein the display control unit is configured to display an icon at the set following position on the display unit.

According to the second aspect, the occupant may understand the set following distance from the display position of the icon.

A third aspect of the present disclosure is either of the above aspects, wherein the display control is configured to display on the display unit a road surface image representing a road surface on which the vehicle is driving, and display the first side in the road surface image with respect to the set following position in a manner different from the second side in the road surface image.

According to the third aspect, the occupant may understand the set following distance from the change in the aspect of the road surface image.

A fourth aspect of the present disclosure is the third aspect, wherein the display control unit is configured to, in a case in which the preceding vehicle following function is active, display the road surface image using a color different from a color that is used in a case in which the preceding vehicle following function is not active.

According to the fourth aspect, the occupant may visually understand whether the preceding vehicle following function of the host vehicle is active.

A fifth aspect of the present disclosure is any of the above aspects, wherein the display control unit is configured to, in a case in which the preceding vehicle following function is active, display the first side in the road surface image with respect to the set following position using a lighter color than a color of the second side in the road surface image.

According to the fifth aspect, the occupant may understand the set following distance from the difference in lightness between the colors of the road surface image.

A sixth aspect of the present disclosure is any of the above aspects, wherein the display control unit is configured to, in a case in which the preceding vehicle following function is active, display the first side in the road surface image and the second side in the road surface image by using colors in a same family.

According to the sixth aspect, colors in the same family are used for the colors of the road surface image on the near side and the far side of the set following icon, so the occupant is unlikely to experience a sense of visual incongruity.

A seventh aspect of the present disclosure is the above aspect, wherein the display control unit is configured to, in a case in which the preceding vehicle following function is active, use colors of families different from the colors in the same family as a color for displaying the road surface image during detection of an accelerator override function and a color for displaying the road surface image during hands-off control.

According to the seventh aspect, during detection of the accelerator override function and during the hands-off control, the road surface image is displayed using colors of families different from the colors of the road surface image that are normally displayed when the preceding vehicle following function is active, so the occupant may understand from the differences in the colors of the road surface image that the accelerator override function is in effect or that the hands-off control is active.

An eighth aspect of the present disclosure is a display control method executed by a computer, the method including: displaying, on a display unit provided in a vehicle, a host vehicle image representing the vehicle and a preceding vehicle image representing a preceding vehicle and arranged in accordance with a relative positional relationship between the vehicle and the preceding vehicle; and displaying a first side on the display unit in a manner different from a second side on the display unit, the first side being a side of the host vehicle image with respect to a set following position that is set based on a following distance setting in a preceding vehicle following function, and the second side being an opposite side of the first side with respect to the set following position.

According to the eighth aspect, by displaying the host vehicle image side (the first side) with respect to the set following position in a manner different from the opposite side (the second side) of the host vehicle image side with respect to the set following position, in the preceding vehicle following function the occupant may intuitively understand from visual information the following distance that has been set.

A ninth aspect of the present disclosure is a non-transitory storage medium storing a program that causes a computer to execute a display control process, the display control process including: displaying, on a display unit provided in a vehicle, a host vehicle image representing the vehicle and a preceding vehicle image representing a preceding vehicle and arranged in accordance with a relative positional relationship between the vehicle and the preceding vehicle; and displaying a first side on the display unit in a manner different from a second side on the display unit, the first side being a side of the host vehicle image with respect to a set following position that is set based on a following distance setting in a preceding vehicle following function, and the second side being an opposite side of the first side with respect to the set following position.

According to the ninth aspect, by displaying the host vehicle image side (the first side) with respect to the set following position in a manner different from the opposite side (the second side) of the host vehicle image side with respect to the set following position, in the preceding vehicle following function the occupant may intuitively understand from visual information the following distance that has been set.

Another aspect of the present disclosure is a program product including a program that causes a computer to execute a display control process, the display control process including:
displaying, on a display unit provided in a vehicle, a host vehicle image representing the vehicle and a preceding vehicle image representing a preceding vehicle and arranged in accordance with a relative positional relationship between the vehicle and the preceding vehicle; and displaying a first side on the display unit in a manner different from a second side on the display unit, the first side being a side of the host vehicle image with respect to a set following position that is set based on a following distance setting in a preceding vehicle following function, and the second side being an opposite side of the first side with respect to the set following position.

According to the present disclosure, in the preceding vehicle following function, the occupant may intuitively understand from visual information the following distance that has been set.

### BRIEF DESCRIPTION OF THE DRAWINGS

FIG. 1 is a schematic view schematically illustrating the front portion of a cabin of a vehicle in an embodiment as viewed from the vehicle rear side;

FIG. 2 is a block diagram illustrating hardware configurations of a vehicle display control device pertaining to the embodiment;

FIG. 3 is a block diagram illustrating functional configurations of the vehicle display control device pertaining to the embodiment;

FIG. 4A to FIG. 4D are drawings illustrating an example of a display screen of a second display unit in an autonomous driving mode, and illustrate display positions of a target bar that differ in accordance with a following distance setting;

FIG. 5A to FIG. 5C are drawings illustrating an example of the display screen of the second display unit in the autonomous driving mode, and illustrate the relationship between the relative positional relationship between a preceding vehicle image and the target bar and control to accelerate/decelerate the vehicle;

FIG. 6 is a drawing illustrating an example of the display screen of the second display unit in a manual driving mode;

FIG. 7 is a drawing illustrating an example of the display screen of the second display unit in the manual driving mode in a state in which an intervention in an accelerator operation is being performed;

FIG. 8 is a drawing illustrating an example of the display screen of the second display unit in the autonomous driving mode in a state in which hands-off control is active;

FIG. 9 is a drawing illustrating an example of the display screen of the second display unit in the autonomous driving mode in a state in which a preceding vehicle is approaching;

FIG. 10A to FIG. 10C are drawings illustrating examples of the display screen of the second display unit in the autonomous driving mode in modification examples; and

FIG. 11 is a flowchart illustrating an example of a flow of a display process in the embodiment.

### DETAILED DESCRIPTION

A vehicle 12 (hereinafter also called “the host vehicle”) to which a vehicle display control device 10 pertaining to an embodiment has been applied will now be described with reference to the drawings. It will be noted that the vehicle 12 of the present embodiment is, as an example, configured to be switchable between an autonomous driving mode and a manual driving mode. The vehicle display control device 10 is an example of a “display control device.” The vehicle 12 is an example of a “host vehicle.”

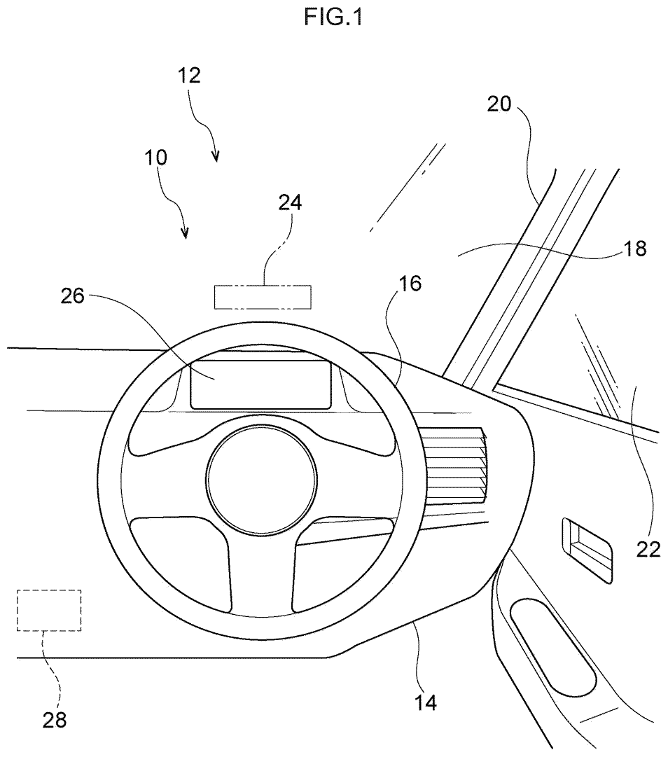

As illustrated in FIG. 1, in the front portion of the cabin in the vehicle 12 is provided an instrument panel 14. The instrument panel 14 extends in the vehicle width direction, and on the vehicle right side (when viewed from a seated occupant of the vehicle) of the instrument panel 14 is provided a steering wheel 16. That is, in the present embodiment, as an example, a right-hand-drive vehicle where the steering wheel 16 is provided on the right side is assumed, and the driver's seat is set on the right side of the vehicle.

On the front end portion of the instrument panel 14 is provided a windshield glass 18. The windshield glass 18 extends in the vehicle vertical direction and the vehicle width direction and separates the cabin interior from the cabin exterior.

The vehicle right-side end portion of the windshield glass 18 is secured to a front pillar 20 on the right side of the vehicle. The front pillar 20 extends in the vehicle vertical direction, and the windshield glass 18 is secured to the vehicle width direction inner end portion of the front pillar 20. Furthermore, the front end portion of a front side glass 22 is secured to the vehicle width direction outer end portion of the front pillar 20. The vehicle left-side end portion of the windshield glass 18 is secured to a front pillar on the left side of the vehicle (not illustrated in the drawings).

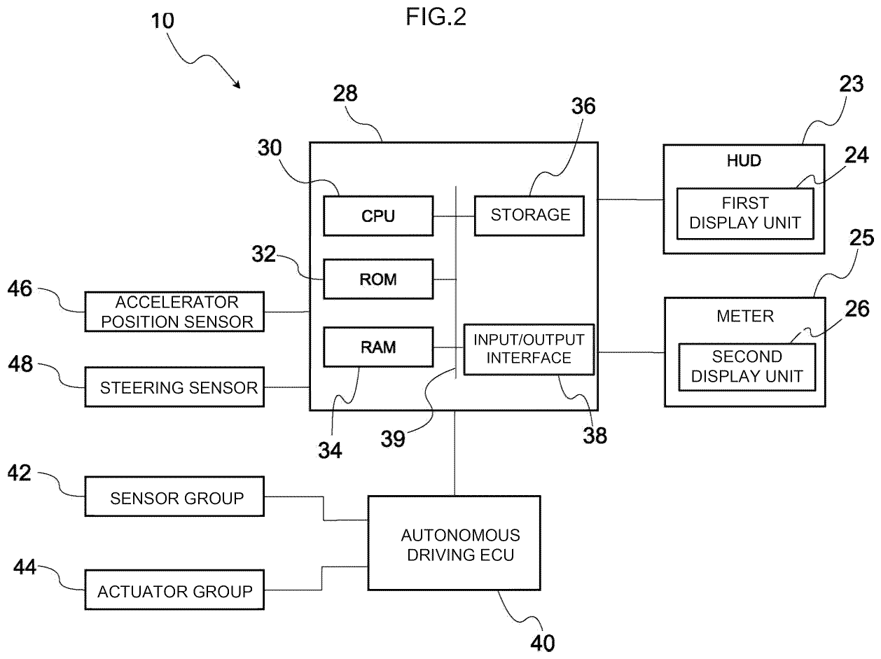

The windshield glass 18 is provided with a first display unit 24. The first display unit 24 is configured by a projection plane projected by a head-up display device 23 illustrated in FIG. 2. Specifically, the head-up display device 23 is provided on the vehicle forward side of the instrument panel 14 and is configured so that video is projected from the head-up display device 23 toward the first display unit 24 of the windshield glass 18.

On the vehicle lower side of the first display unit 24 is provided a second display unit 26. The second display unit 26 is a display unit displayed on a meter 25, and the meter 25 is positioned on the vehicle forward side of the driver's seat in the instrument panel 14. The first display unit 24 and the second display unit 26 are provided in positions where the driver is able to see them. Furthermore, a vehicle display system is configured by the vehicle display control device 10, the first display unit 24, and the second display unit 26. The first display unit 24 and the second display unit 26 are an example of a “display unit.”

### (Hardware Configurations of Vehicle Display Control Device 10)

As illustrated in FIG. 2, the vehicle display control device 10 of the present embodiment is configured to include an electronic control unit (ECU) 28.

The ECU 28 is configured to include a central processing unit (CPU, i.e., a processor) 30, a read-only memory (ROM) 32, a random-access memory (34), a storage 36, and an input/output interface 38. These configurations are communicably interconnected via an internal bus 39.

The CPU 30 is a central arithmetic processing unit, executes various types of programs, and controls each part. That is, the CPU 30 reads programs from the ROM 32 or the storage 36 and executes the programs using the RAM 34 as a workspace. Furthermore, the CPU 30 controls each of the above configurations and performs various types of arithmetic processing in accordance with programs recorded in the ROM 32 or the storage 36.

The ROM 32 stores various types of programs and various types of data. The RAM 34 temporarily stores programs or data as a workspace. The storage 36 is configured by a hard disk drive (HDD) or a solid-state drive (SSD) and is a non-transitory recording medium that stores various types of programs, including an operating system, and various types of data. In the present embodiment, the ROM 32 or the storage 36 stores a display program for performing a display process. Furthermore, various types of input/output devices are connected to the input/output interface 38.

Here, the ECU 28 is electrically connected to an autonomous driving ECU 40. Similarly to the ECU 28, the autonomous driving ECU 40 is configured to include a CPU, a ROM, a RAM, a storage, and an input/output interface (not illustrated in the drawings).

Connected to the autonomous driving ECU 40 are a sensor group 42, which detects the current conditions of the vehicle, and an actuator group 44, which controls the driving of the vehicle. The sensor group 42 includes plural sensors among various types of sensors such as cameras, radar, lidar (Light Detection and Ranging or Laser Imaging Detection and Ranging), and a global positioning system (GPS) sensor. The cameras captures images of the area around the vehicle. The radar uses radio waves to detect distances to and directions of objects around the vehicle. The lidar uses laser light to detect distances to and directions of objects around the vehicle. The GPS sensor detects the current position of the vehicle. In addition to these, the sensor group 42 is configured to include a sensor that detects the state of the occupant. For example, the sensor group 42 may be configured to include a biometric sensor that detects the occupant's heart rate and level of alertness.

The actuator group 14 includes an acceleration/deceleration actuator, which regulates acceleration/deceleration of the vehicle, and a steering actuator, which drives a steering device of the vehicle. The autonomous driving ECU 40 autonomously drives the vehicle by controlling operations of the actuator group 44 in accordance with the current conditions of the vehicle detected by the sensor group 42. It will be noted that a storage unit of the autonomous driving ECU 40 stores a planned route representing a route the vehicle is planning to drive, and the autonomous driving ECU 40 drives the vehicle along the planned route stored in the storage unit.

Connected to the ECU 28 are an accelerator position sensor 46 and a steering sensor 48. The accelerator position sensor 46 is a sensor that detects the position of an accelerator pedal (not illustrated in the drawings) provided in front of the lower portion of the driver's seat. Furthermore, the steering sensor 48 is a sensor that detects loads applied to the steering wheel 16 by the occupant. That is, the steering sensor 48 of the present embodiment is configured to not detect loads in a case in which the steering wheel 16 is being operated by the autonomous driving ECU 40 in the autonomous driving mode, and to detect loads when the occupant is operating the steering wheel 16.

### (Functional Configurations of Vehicle Display Control Device 10)

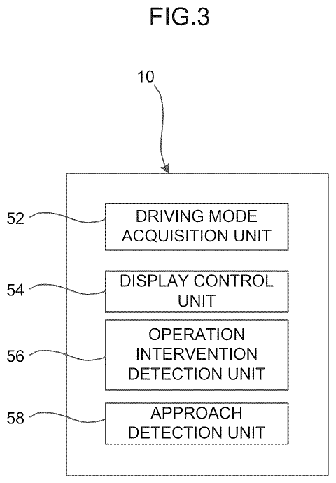

The vehicle display control device 10 realizes various types of functions using the above hardware resources. The functional configurations realized by the vehicle display control device 10 will now be described with reference to FIG. 3.

As illustrated in FIG. 3, the vehicle display control device 10 is configured to include, as functional configurations, a driving mode acquisition unit 52, a display control unit 54, an operation intervention detection unit 56, and an approach detection unit 58. Each of these functional configurations is realized by the CPU 30 of the ECU 28 reading and executing a program.

The driving mode acquisition unit 52 acquires information as to which of a manual driving mode and an autonomous driving mode the driving mode of the vehicle 12 is. Here, “manual driving mode” in the present embodiment refers to a driving mode where the vehicle 12 is being driven via driving operations by the occupant. Furthermore, “autonomous driving mode” in the present embodiment refers to a driving mode where the vehicle 12 is being driven without accelerator operations by the occupant. The autonomous driving mode of the present embodiment refers, as an example, to a mode in which adaptive cruise control (ACC) being active. ACC is a driving assistance function that uses the camera and radar (a monocular camera and a mm Wave radar) included in the sensor group 42 to perceive a preceding vehicle and assist in following the preceding vehicle while maintaining a following distance based on vehicle speed. The driving mode acquisition unit 52 acquires the information relating to the driving mode based on, for example, signals from the autonomous driving ECU 40. Adaptive cruise control is an example of a “preceding vehicle following function.”

Furthermore, the driving mode acquisition unit 52 acquires information as to whether hands-off control is active when the driving mode of the vehicle 12 is the autonomous driving mode. Hands-off control is, for example, an advanced driving assistance function that performs steering and acceleration/deceleration control on motorways under driver supervision. The driving mode acquisition unit 52 acquires the information relating to the hands-off control based on, for example, signals from the autonomous driving ECU 40.

The display control unit 54 displays information about the area around the vehicle 12 on the first display unit 24 and the second display unit 26 provided in the cabin. Specifically, the display control unit 54 acquires signals from the sensor group 42 and displays on the first display unit 24 and the second display unit 26 information about the area around the vehicle 12 based on the acquired signals. The information about the area around the vehicle 12 includes information about the relative positional relationship between the vehicle 12 and a preceding vehicle.

Furthermore, the display control unit 54 displays on the first display unit 24 and the second display unit 25 a pre-set following distance (hereinafter also called “the set following distance”) when the driving mode acquired by the driving mode acquisition unit 52 is at least the autonomous driving mode. Specifically, the display control unit 54 acquires the set following distance in the autonomous driving mode and displays on the first display unit 24 and the second display unit 26 information representing the set following distance that has been acquired.

Additionally, the display control unit 54 changes the display screens displayed on the first display unit 24 and the second display unit 26 depending on whether the driving mode acquired by the driving mode acquisition unit 52 is the manual driving mode or the autonomous driving mode. Furthermore, the display control unit 54 changes the display screens displayed on the first display unit 24 and the second display unit 26 in a case in which an intervention in the driving operation by the occupant is detected by the operation intervention detection unit 56, and in a case in which the driving mode acquisition unit 52 acquires information that the hands-off control is active. Moreover, the display control unit 54 changes the display screens displayed on the first display unit 24 and the second display unit 26 in a case in which the approach detection unit 58, described later, detects the approach of a preceding vehicle.

The operation intervention detection unit 56 detects interventions in the driving operation by the driver in a case in which the driving mode acquired by the driving mode acquisition unit 52 is the autonomous driving mode. That is, the operation intervention detection unit 56 functions only when the driving mode is the autonomous driving mode and does not function in a case in which the driving mode is the manual driving mode. Furthermore, the operation intervention detection unit 56 determines that the occupant is intervening in the accelerator operation in a case in which it detects that the accelerator pedal is moving from an initial position based on a signal from the accelerator position sensor 46 in the autonomous driving mode. Moreover, the operation intervention detection unit 56 determines that the occupant is intervening in the steering operation in a case in which it detects that the occupant has applied a load to the steering wheel 16 based on a signal from the steering sensor 48 in the autonomous driving mode.

The approach detection unit 58 detects whether a preceding vehicle is approaching the host vehicle. The approach detection unit 58 acquires information relating to the approach of a preceding vehicle based on, for example, a signal from the autonomous driving ECU 40.

### (Display Screen)

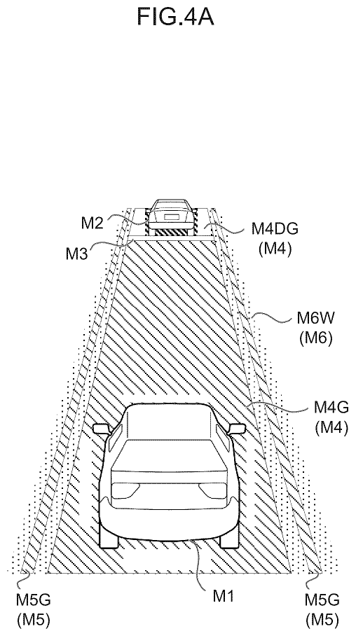

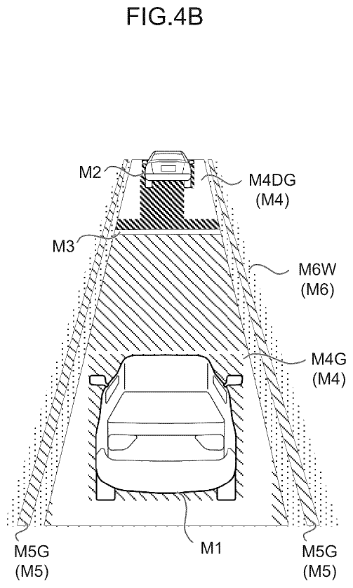

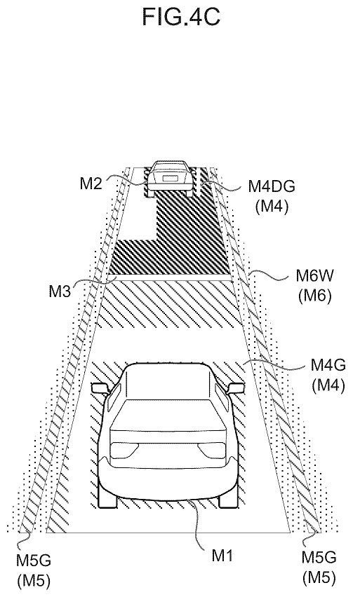

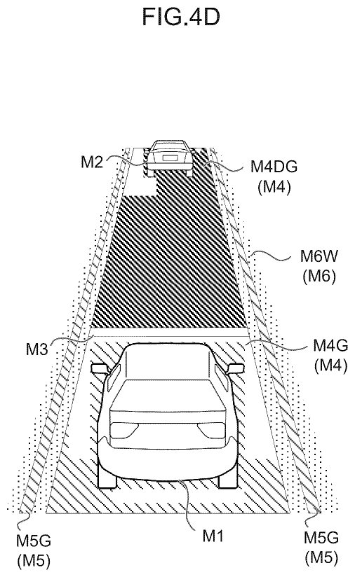

Below, part of the display screen of the second display unit 26 displayed by the function of the display control unit 54 in the autonomous driving mode will be described with reference to FIG. 4A to FIG. 10C.

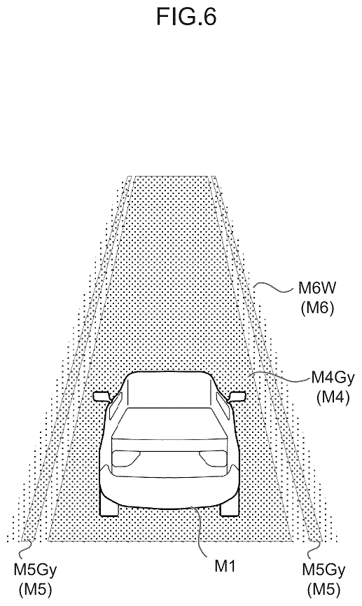

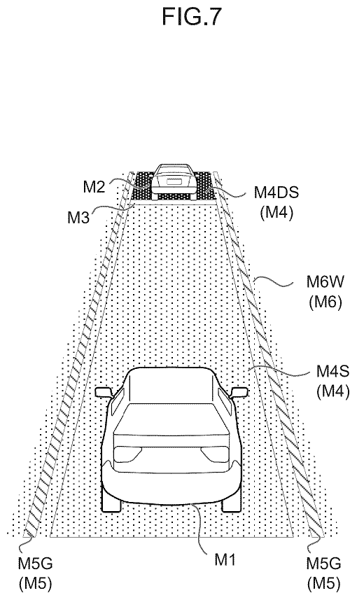

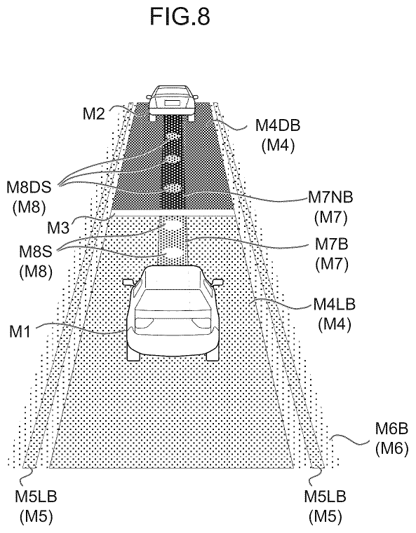

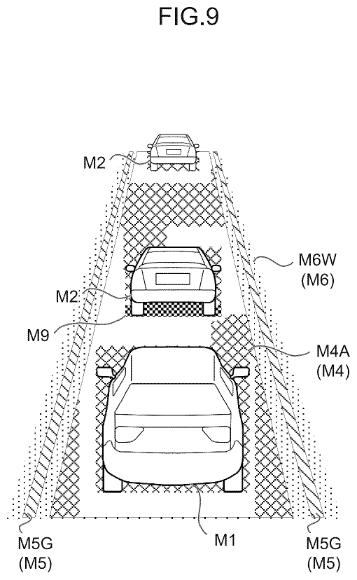

FIG. 4A to FIG. 4D are drawings illustrating display positions of a target bar M3 that differ in accordance with a following distance setting in the autonomous driving mode. As illustrated in FIG. 4A to FIG. 4D, in the autonomous driving mode, a host vehicle image M1 resembling or representing the vehicle 12, a preceding vehicle image M2 resembling or representing a preceding vehicle driving in front of the vehicle 12, a target bar M3 that is an icon representing the set following distance in the autonomous driving mode, a road surface image M4 representing the road surface of the driving lane of the vehicle 12, boundary line images M5 representing the boundary lines of the driving lane of the vehicle 12, and image effects M6 representing effects applied to the images are displayed on the second display unit 26. The road surface image M4 of the present embodiment includes road surface images M4G and M4DG, M4Gy (see FIG. 6), M4S and M4DS (see FIG. 7), M4LB and M4DB (see FIG. 8), and M4A (see FIG. 9) that have different displayed colors (hue, lightness, and saturation information). Furthermore, the boundary line images M5 include boundary lines images M5G, M5Gy (see FIG. 6), and M5LB (see FIG. 8) that have different displayed colors. Additionally, the image effects M6 include image effects M6W and M6B (see FIG. 8) that have different displayed colors. The target bar M3 is an example of an “icon.”

The host vehicle image M1 is displayed in a display area in the second display unit 26. Additionally, the host vehicle image M1 is displayed superimposed on the road surface image M4 in the lower portion of this display area.

The preceding vehicle image M2 is displayed superimposed on the road surface image M4. Furthermore, the preceding vehicle image M2 is displayed such that its display position and size are changed in accordance with the relative positional relationship between the vehicle 12 and the preceding vehicle. For example, as the vehicle 12 and the preceding vehicle become farther apart, the preceding vehicle image M2 is reduced in size and displayed in the upper portion of the display area in the second display unit 26.

The target bar M3 is displayed superimposed on the road surface image M4 forward of the host vehicle image M1. Here, “forward of the host vehicle image M1” is the traveling direction of the vehicle 12 and coincides with the upward direction in the second display unit 26. The target bar M3 is displayed such that its position is changed in accordance with the set following distance of the vehicle 12 in the autonomous driving mode. It will be noted that the position where the target bar M3 is displayed may also be changed in accordance with the speed of the vehicle 12. The position that is changed in accordance with the set following distance of the vehicle 12 in the autonomous driving mode is an example of a “set following position.”

The road surface image M4 is displayed such that the host vehicle image M1, the preceding vehicle image M2, and the target bar M3 are superimposed on it. Furthermore, the road surface image M4 is displayed in different manners on the near side and the far side of the target bar M3. Here, “near side” is the direction toward the host vehicle image M1 and coincides with the downward direction in the second display unit 26. Furthermore, “far side” is the direction away from the host vehicle image M1 and coincides with the upward direction in the second display unit 26. For example, the road surface image M4G, which is displayed on the near side of the target bar M3, is displayed in green, and the road surface image M4DG, which is displayed on the far side of the target bar M3, is displayed in dark green. The near side of the target bar M3 is an example of “a side of the host vehicle image with respect to a set following position”, that is, “a first side”, and the far side of the target bar M3 is an example of “an opposite side of the host vehicle image side with respect to the set following position”, that is, “a second side”. Green and dark green are an example of “colors in the same family.”

The boundary line images M5 are displayed such that gaps are left along the road surface image M4 in each of the leftward direction and the rightward direction of the road surface image M4. Here, “leftward direction” and “rightward direction” are the leftward direction and the rightward direction as one faces the traveling direction of the vehicle 12 and coincide with the leftward direction and the rightward direction of the second display unit 26. The boundary line images M5 are displayed in different manners depending on the active state of the driving assistance function of the vehicle 12. For example, the boundary line images M5G, which are displayed when a lane departure alert (LDA) function is enabled, are displayed in green. In contrast, the boundary line images M5Gy, which are displayed when the LDA function is not enabled, are displayed in gray. LDA is a driving assistance function which, when the system judges that the vehicle may depart from its lane, notifies the driver using a display, buzzer, or vibration of the steering wheel to thereby prompt the driver to carry out a departure avoidance maneuver. Moreover, the LDA function assists in inhibiting lane departures by displays and the application of steering force to the steering wheel.

The image effects M6 are displayed around the road surface image M4 and the boundary line images M5. For example, the image effects M6 are displayed like white mist and enhance the visibility of the road surface image M4 and the boundary line images M5.

In the present embodiment, as an example, as illustrated in FIG. 4A, in a case in which the following distance setting is set to a fourth stage among four stages, the target bar M3 is displayed in a position about 1/10 of the road surface image M4 from the back. Furthermore, the road surface image M4G is displayed on the near side of the target bar M3, and the road surface image M4DG is displayed on the far side (the same applies to FIG. 4B to FIG. 4D below). As illustrated in FIG. 4B, in a case in which the following distance setting is set to a third stage among the four stages, the target bar M3 is displayed in a position about ⅕ of the road surface image M4 from the back. As illustrated in FIG. 4C, in a case in which the following distance setting is set to a second stage among the four stages, the target bar M3 is displayed in a position about ⅓ of the road surface image M4 from the back. As illustrated in FIG. 4D, in a case in which the following distance setting is set to a first stage among the four stages, the target bar M3 is displayed in a position about ½ of the road surface image M4 from the back. Displaying the target bar M3 in different display positions in this way indicates which stage the following distance setting is set to. Furthermore, displaying the road surface image M4 in different colors on the near side and the far side of the target bar M3 indicates that the near side of the target bar M3 is a control area in the autonomous driving mode. In FIG. 4A to FIG. 4D, information representing the set following distance includes the target bar M3 and the road surface image M4.

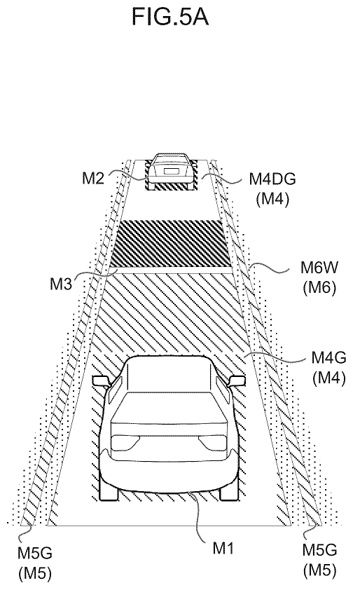

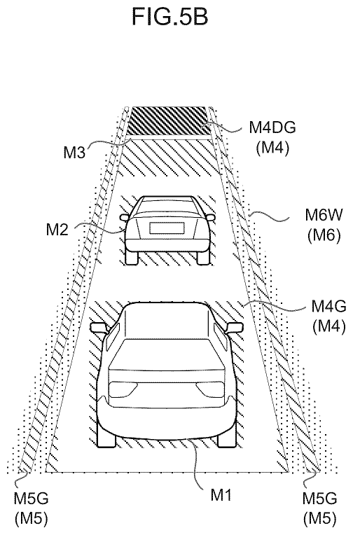

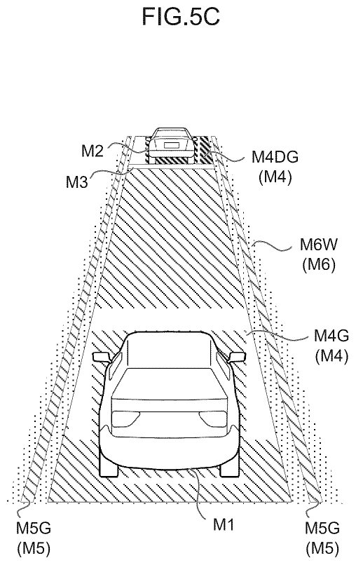

FIG. 5A to FIG. 5C are drawings illustrated the relationship between the relative positional relationship between the preceding vehicle image M2 and the target bar M3 and control to accelerate/decelerate the vehicle 12 in the autonomous driving mode. As illustrated in FIG. 5A, in a case in which the preceding vehicle image M2 is being displayed on the far side of the target bar M3, this indicates that the vehicle 12 will accelerate until the position of the preceding vehicle image M2 coincides with the position of the target bar M3. As illustrated in FIG. 5B, in a case in which the preceding vehicle image M2 is being displayed on the near side of the target bar M3, this indicates that the vehicle 12 will decelerate until the preceding vehicle image M2 is positioned on the far side of the target bar M3. As illustrated in FIG. 5C, in a case in which the position of the target bar M3 and the position of the preceding vehicle image M2 coincide, this indicates that the vehicle 12 will neither accelerate nor decelerate (i.e., will keep a constant speed). Displaying the relative positional relationship between the preceding vehicle image M2 and the target bar M3 in this way indicates control to accelerate/decelerate the vehicle 12.

FIG. 6 illustrates the display screen of the second display unit 26 in the manual driving mode. In the present embodiment, as an example, in a case in which the driving mode acquisition unit 52 acquires information that the driving mode of the vehicle 12 has been switched from the autonomous driving mode to the manual driving mode, the display control unit 54 changes the colors of the road surface image M4 and the boundary line images M5 on the second display unit 26 as illustrated in FIG. 6 from what they are in FIG. 4A and hides the preceding vehicle image M2 and the target bar M3.

For example, in a case in which the driving mode is the autonomous driving mode as illustrated in FIG. 4A, the road surface image M4G and the boundary line images M5G are displayed. In contrast, in a case in which the driving mode is the manual driving mode as illustrated in FIG. 6, the display control unit 54 changes the colors of the road surface image M4 and the boundary line images M5 and displays the road surface image M4Gy and the boundary line images M5Gy. Specifically, the road surface image M4Gy and the boundary line images M5Gy are displayed in gray. At this time, the display control unit 54 does not change the host vehicle image M1 and the image effects M6.

As illustrated in FIG. 6, the road surface image M4G changes to the road surface image M4Gy, and the boundary line images M5G change to the boundary line images M5Gy. Furthermore, the preceding vehicle image M2 and the target bar M3 are hidden. Hiding the preceding vehicle image M2 and the target bar M3 and changing the colors of the road surface image M4 and the boundary line images M5 in this way indicates that the driving mode has been switched to the manual driving mode. In a case in which the driving mode is switched back to the autonomous driving mode, the display screen may be switched to the display screen illustrated in any one of FIG. 4A to FIG. 4D.

FIG. 7 illustrates the display screen of the second display unit 26 in a state in which an intervention in the accelerator operation is being performed in the autonomous driving mode. In the present embodiment, as an example, in a case in which the operation intervention detection unit 56 detects an intervention in the accelerator operation, the display control unit 54 changes the color of the road surface image M4 on the second display unit 26 as illustrated in FIG. 7 from what it is in FIG. 4A. The detection of the intervention in the accelerator operation is an example of a “detection of an accelerator override function.”

For example, as illustrated in FIG. 4A, in a normal state in which an intervention in the accelerator operation is not being detected, the road surface images M4G and M4DG are displayed. In contrast, as illustrated in FIG. 7, in a case in which an intervention in the accelerator operation is detected, the display control unit 54 changes the colors of the road surface image M4 and displays the road surface images M4S and M4DS. Specifically, the road surface image M4S, which is displayed on the near side of the target bar M3, is displayed in silver, and the road surface image M4DS, which is displayed on the far side of the target bar M3, is displayed in dark silver. At this time, the display control unit 54 does not change the host vehicle image M1, the preceding vehicle image M2, the boundary line images M5, and the image effects M6. Silver and dark silver are an example of “colors of a different family.”

As illustrated in FIG. 7, the display control unit 43 changes the road surface image M4G to the road surface image M4S and changes the road surface image M4DG to the road surface image M4DS. Changing the colors of the road surface image M4 in this way indicates that an intervention in the accelerator operation is in effect. In FIG. 7 information representing the set following distance includes the target bar M3 and the road surface image M4.

FIG. 8 illustrates the display screen of the second display unit 26 in a state in which the hands-off control is active in the autonomous driving mode. In the present embodiment, as an example, in a case in which the driving mode acquisition unit 52 acquires information that the hands-off control is active, the display control unit 54 changes the colors of the road surface image M4, the boundary line images M5, and the image effects M6 on the second display unit 26 as illustrated in FIG. 8 from what they are in FIG. 4A.

For example, as illustrated in FIG. 4A, in a state in which the hands-off control is not active in the autonomous driving mode, the road surface images M4G and M4DG, the boundary line images M5G, and the image effects M6W are displayed. In contrast, as illustrated in FIG. 8, in a case in which the driving mode acquisition unit 52 acquires information that the hands-off control is active, the display control unit 54 changes the colors of the road surface image M4, the boundary line images M5, and the image effects M6 and displays the road surface images M4LB and M4DB, the boundary line images M5LB, and the image effects M6B. Specifically, the road surface image M4LB, which is displayed on the near side of the target bar M3, and the boundary line images M5LB are displayed in light blue, and the road surface image M4DB, which is displayed on the far side of the target bar M3, is displayed in dark blue. Furthermore, the image effects M6B are displayed in blue. At this time, the display control unit 54 does not change the host vehicle image M1 and the preceding vehicle image M2. Furthermore, a trajectory image M7 and speed marks M8 described later are displayed. Blue and dark blue are an example of “colors of a different family.”

As illustrated in FIG. 8, between the host vehicle image M1 and the preceding vehicle image M2, a trajectory image M7 representing the planned driving route of the vehicle 12 and speed marks M8 corresponding to the speed of the vehicle 12 are displayed. The trajectory image M7 of the present embodiment includes trajectory images M7B and M7NB that have different colors. Furthermore, the speed marks M8 include speed marks M8S and M8DS that have different colors.

The trajectory image M7 is displayed substantially in the shape of a band and, when the vehicle 12 is traveling straight, is displayed in a substantially straight line in the vertical direction. Furthermore, the trajectory image M7 is displayed in different ways on the near side and the far side of the target bar M3. For example, the trajectory image M7B, which is displayed on the near side of the target bar M3, is displayed in blue, and the trajectory image M7NB, which is displayed on the far side of the target bar M3, is displayed in navy blue. Additionally, although the drawings do not illustrate this, in a case in which the vehicle 12 makes a right or left turn and a case where the vehicle 12 goes around a curve, the trajectory image M7 is displayed such that it curves along the planned driving route of the vehicle 12.

A plurality of the speed marks M8 are displayed spaced apart from each other and superimposed on the trajectory image M7. In FIG. 8, five speed marks M8 are displayed. Furthermore, the speed marks M8 are displayed in different ways on the near side and the far side of the target bar M3. For example, the speed marks M8S, which are displayed on the near side of the target bar M3, are displayed in silver, and the speed marks M8DS, which are displayed on the far side of the target bar M3, are displayed in dark silver. The speed marks M8 are displayed such that the spacing between them changes in accordance with the speed of the vehicle 12. For example, in a case in which the speed of the vehicle 12 is lower than what it is in FIG. 8, the speed marks M8 are displayed such that the spacing between them becomes narrower. Conversely, in a case in which the speed of the vehicle 12 is faster than what it is in FIG. 8, the speed marks M8 are displayed such that the spacing between them becomes wider.

Changing the colors of the road surface image M4, the boundary line images M5, and the image effects M6 and displaying the trajectory image M7 and the speed marks M8 in this way indicates that the hands-off control is enabled. In FIG. 8, information representing the set following distance includes the target bar M3, the road surface image M4, the trajectory image M7, and the speed marks M8.

FIG. 9 illustrates the display screen of the second display unit 26 in a state in which a preceding vehicle is approaching in the autonomous driving mode. In the present embodiment, as an example, when the approach detection unit 58 detects the approach of a preceding vehicle, the display control unit 54 changes the color of the road surface image M4 on the second display unit 26 as illustrated in FIG. 9 from what it is in FIG. 4A and hides the target bar M3.

For example, as illustrated in FIG. 4A, in a normal state in which the approach detection unit 58 is not detecting the approach of a preceding vehicle, the road surface images M4G and M4DG and the target bar M3 are displayed. In contrast, as illustrated in FIG. 9, in a case where the approach of a preceding vehicle is detected, the display control unit 54 changes the color of the road surface image M4 and displays the road surface image M4A and hides the target bar M3. Specifically, the road surface image M4A, which is displayed as the entire road surface image, is displayed in amber. At this time, the display control unit 54 does not change the host vehicle image M1, the preceding vehicle image M2, the boundary line images M5, and the image effects M6. Furthermore, a warning image M9, described later, is displayed under the preceding vehicle image M2 whose approach has been detected.

As illustrated in FIG. 9, a warning image M9 representing the approach of a preceding vehicle is displayed under the preceding vehicle image M2 representing the preceding vehicle whose approach to the host vehicle has been detected. The warning image M9 is displayed superimposed on the road surface image M4A and with the preceding vehicle image M2 superimposed on it. For example, the warning image M9 is displayed in orange. Hiding the target bar M3 and changing the color of the road surface image M4 and displaying the warning image M9 in this way indicates that a preceding vehicle is approaching. The display screen may be switched to the display screen illustrated in any one of FIG. 4A to FIG. 4D at the point in time when it becomes possible to display the appropriate following distance between the host vehicle and the preceding vehicle whose approach was detected.

Similar images as those on the second display unit 26 are displayed on the first display unit 24. In the present embodiment, the display area of the first display unit 24 is narrower than the display area of the second display unit 26, so the first display unit 24 is configured such that some of the images on the second display unit 26 are displayed thereon. For example, on the first display unit 24 are displayed the target bar M3, the road surface image M4, and the boundary line images M5.

### MODIFICATION EXAMPLES

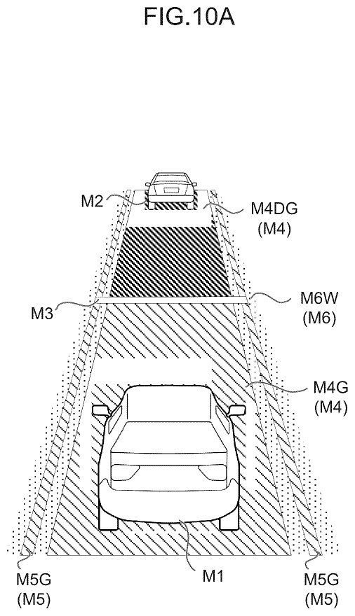

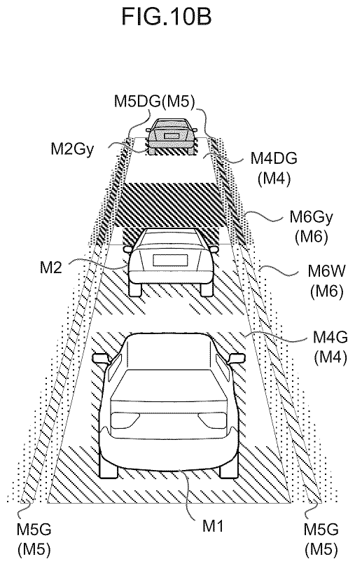

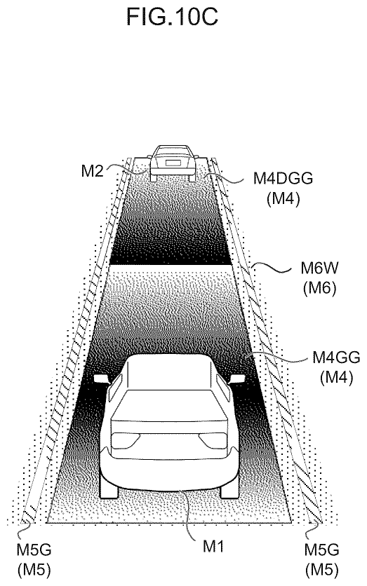

FIG. 10A to FIG. 10C illustrate modification examples of the display screen of the second display unit 26 in the autonomous driving mode.

As illustrated in FIG. 10A, the display control unit 54 may also display the target bar M3 such that it is superimposed on both the road surface image M4 and the boundary line images M5. That is, in FIG. 10A, compared with FIG. 4C, the target bar M3 is displayed such that it is longer in the left-right direction. In this way, the display control unit 54 may change the left-right direction length of and display the target bar M3.

Furthermore, as illustrated in FIG. 10B, the target bar M3 may be hidden. At the same time, the preceding vehicle image M2, the road surface image M4, the boundary line images M5, and the image effects M6 may be displayed by the display control unit 54 in different ways on the near side and the far side of a position representing the set following distance. For example, on the near side of the position representing the set following distance are displayed the preceding vehicle image M2, the road surface image M4G, the boundary line images M5G, and the image effects M6W. In contrast, on the far side of the position representing the set following distance are displayed a preceding vehicle image M2Gy, the road surface image M4DG, boundary line images M5DG, and image effects M6Gy. The preceding vehicle image M2Gy and the image effects M6Gy in the modification example illustrated in FIG. 10B are displayed in gray, and the boundary line images M5DG are displayed in dark green. That is, in FIG. 10B, the position at which the colors of the preceding vehicle image M2, the road surface image M4, the boundary line images M5, and the image effects M6 greatly change indicates the position of the set following distance. In this way, the display control unit 54 may hide the target bar M3 and display the preceding vehicle image M2, the boundary line images M5, and the image effects M6 in different ways on the near side and the far side of the position representing the set following distance. The display control unit 54 need only change the color of at least one of the preceding vehicle image M2, the road surface image M4, the boundary line images M5, and the image effects M6 and display them. Furthermore, in FIG. 10B information representing the set following distance includes the preceding vehicle image M2, the road surface image M4, the boundary line images M5, and the image effects M6. The position representing the set following distance is an example of a “set following position.”

Additionally, as illustrated in FIG. 10C, the target bar M3 may also be hidden. At the same time, the road surface image M4 is displayed, by the function of the display control unit 54, in different gradations on the near side and the far side of the position representing the set following distance. For example, a road surface image M4GG displayed on the near side of the position representing the set following distance is displayed in gradations of green that gradually become lighter heading in the upward and downward directions from the center of the image. Furthermore, a road surface image M4DGG displayed on the far side of the position representing the set following distance is displayed in gradations of dark green that gradually become lighter heading in the upward direction from the lower bottom portion of the image. That is, in FIG. 10C, the position at which the lightness of the gradations in the road surface image M4 significantly changes indicates the set following distance. In this way, the display control unit 54 may display the road surface image M4 in different gradations on the near side and the far side of the set following distance. It will be noted that the display control unit 54 may also display the boundary line images M5 and the image effects M6 in gradations.

### (Operation)

Next, the operation of the present embodiment will be described.

### (Example of Display Process)

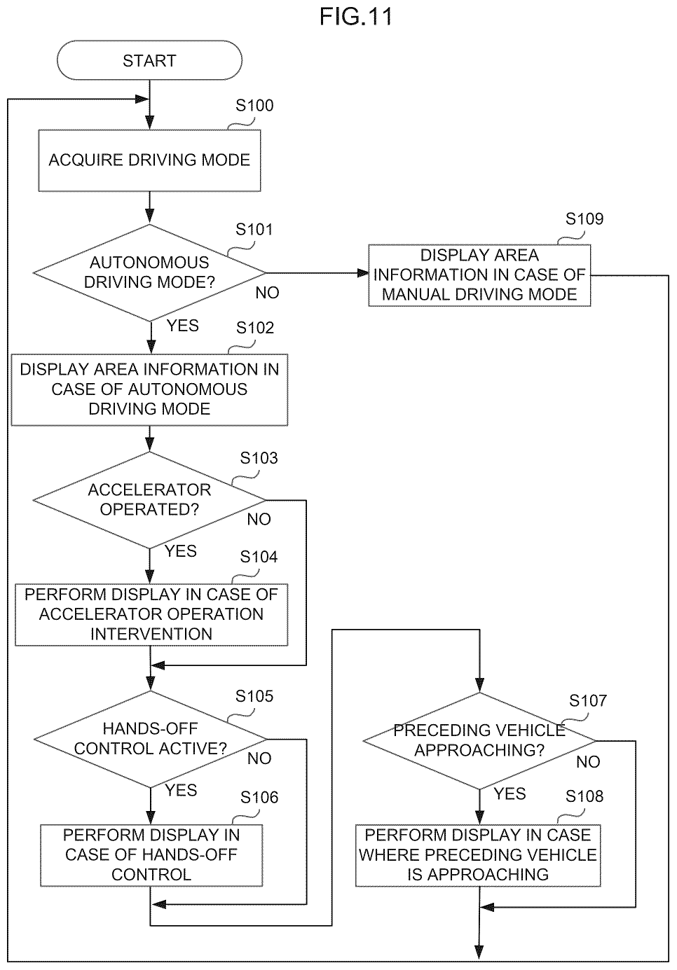

FIG. 11 is a flowchart illustrating an example of a flow of a display process executed by the vehicle display control device 10. The display process is executed by the CPU 30 of the ECU 28 reading a program from the ROM 32 or the storage 36, loading it to the RAM 34, and executing it. The display process is executed by the CPU 30 functioning as the driving mode acquisition unit 52, the display control unit 54, the operation intervention detection unit 56, and the approach detection unit 58. As an example, the display process illustrated in FIG. 11 is a process that is repeatedly executed while the vehicle 12 is being driven.

As illustrated in FIG. 11, in step S100 the CPU 30 acquires the driving mode. Specifically, the CPU 30 acquires information of the driving mode of the vehicle 12, which is the manual driving mode or the autonomous driving mode.

In step S101 the CPU 30 determines whether the driving mode of the vehicle 12 is the autonomous driving mode. In a case in which the driving mode of the vehicle 12 acquired by the driving mode acquisition unit 52 is the autonomous driving mode, the CPU 30 makes an affirmative determination in step S101 and moves to the process of step S102. In a case in which the driving mode of the vehicle 12 acquired by the driving mode acquisition unit 52 is the manual driving mode, the CPU 30 proceeds to step S109.

In step S102 the CPU 30 displays area information in the case of the autonomous driving mode. Specifically, the CPU 30 acquires signals from the sensor group 42 and displays on the first display unit 24 and the second display unit 26 information about the area around the vehicle 12 based on the acquired signals. For example, in step S102 the CPU 30 displays the host vehicle image M1, the preceding vehicle image M2, the target bar M3, the road surface image M4, the boundary line images M5, and the image effects M6 on the second display unit 26 as illustrated in FIG. 4A. The CPU 30 also displays on the first display unit 24 similar images as those on the second display unit 26.

In step S103 of FIG. 11 the CPU 30 determines whether an intervention in the accelerator operation has been performed. Specifically, in a case in which the CPU 30 detects an intervention in the accelerator operation based on a signal from the accelerator position sensor 46, an affirmative determination is made in step S103 and the process moves to step S104.

In a case in which an intervention in the accelerator operation is not detected in step S103, the CPU 30 makes a negative determination in step S103 and moves to the process of step S105.

In step S104 the CPU 30 performs a display in the case of an accelerator operation intervention. Specifically, the CPU 30 changes the color of the road surface image M4 on the second display unit 26 as illustrated in FIG. 7. Although not illustrated in the drawings, the display is changed in the similar way also on the first display unit 24.

In step S105 of FIG. 11 the CPU 30 determines whether or not the hands-off control is active. Specifically, in a case in which the CPU 30 acquires information that hands-off control is active, an affirmative determination is made in step S105 and the process moves to step S106.

In a case in which information that the hands-off control is active is not acquired in step S105, the CPU 30 makes a negative determination in step S105 and moves to the process of step S107.

In step S106 the CPU 30 performs a display in the case of the hands-off control. Specifically, the CPU 30 changes the colors of the road surface image M4, the boundary line images M5, and the image effects M6 on the second display unit 26 as illustrated in FIG. 8. The CPU 30 also displays the trajectory image M7 representing the planned driving route and the speed marks M8. Although not illustrated in the drawings, the display is changed in the similar way also on the first display unit 24.

In step S107 of FIG. 11 the CPU 30 determines whether or not a preceding vehicle is approaching. Specifically, in a case in which the CPU 30 detects that a preceding vehicle is approaching, an affirmative determination is made in step S107 and the process moves to step S108.

In a case in which the approach of a preceding vehicle is not detected in step S107, the CPU 30 makes a negative determination in step S107 and moves to step S100.

In step S108 the CPU 30 performs a display in the case of a preceding vehicle is approaching. Specifically, the CPU 30 hides the target bar M3 on the second display unit 26 and changes the color of the road surface image M4 as illustrated in FIG. 9. The CPU 30 also displays the warning image M9 indicating the approach of a preceding vehicle. Although not illustrated in the drawings, the display is changed in the similar way also on the first display unit 24. Then, the CPU 30 moves to step S100.

In step 109 the CPU 30 displays area information in the case of the manual driving mode. Specifically, the CPU 30 hides the preceding vehicle image M2 and the target bar M3 on the second display unit 26 and changes the colors of the road surface image M4 and the boundary line images M5 as illustrated in FIG. 6. Although not illustrated in the drawings, the display is changed in the similar way also on the first display unit 24. Then, the CPU 30 moves to step S100.

As described above, the vehicle display control device 10 pertaining to the present embodiment displays the host vehicle image M1 and the preceding vehicle image M2 on the first display unit 24 and the second display unit 26, displays the target bar M3 whose display position moves up and down in accordance with the following distance setting in the autonomous driving mode, and displays the near side of the target bar M3 in a way different from the far side of the target bar M3. Because of this, in the adaptive cruise control function, the occupant may intuitively understand from visual information the following distance that has been set. Furthermore, the occupant may understand the set following distance from the display position of the target bar M3.

The vehicle display control device 10 pertaining to the present embodiment displays the road surface image M4G on the near side of the target bar M3 in a way different from the road surface image M4DG on the far side of the target bar M3. Therefore, the occupant may understand the set following distance from the change in the aspect of the road surface image M4. Furthermore, a wider range of the set following distance information may be displayed compared with a case where the set following distance information is displayed using just the display position of the target bar M3 and, therefore, the amount of visual information for allowing the occupant to understand the set following distance may be increased. Additionally, the occupant may visually understand the control area in the autonomous driving mode.

In the autonomous driving mode, the vehicle display control device 10 pertaining to the present embodiment displays the road surface image M4 using a color different from that which it uses in the manual driving mode. Therefore, the occupant may visually understand which of the manual driving mode and the autonomous driving mode the driving mode of the vehicle 12 is.

In the autonomous driving mode, the vehicle display control device 10 pertaining to the present embodiment displays in green the road surface image M4G on the near side of the target bar M3 and displays in dark green the road surface image M4DG on the far side of the target bar M3. Because of this, the occupant may understand the set following distance from the difference in lightness between the colors of the road surface image M4. Furthermore, since colors in the same family are used for the colors of the road surface image M4 on the near side and the far side of the target bar M3, the occupant is unlikely to experience a sense of visual incongruity.

In the autonomous driving mode, the vehicle display control device 10 pertaining to the present embodiment displays the road surface image M4S in silver and the road surface image M4DS in dark silver in a case in which an intervention in the accelerator operation is in effect, and displays the road surface image M4B in blue and the road surface image M4DB in dark blue in a case in which the hands-off control is active. Therefore, in each case the road surface image M4 is displayed using colors of families different from those of the road surface images M4G and M4DG. Thus, the occupant may understand from the differences in the color of the road surface image that an intervention in the accelerator operation is in effect or that the hands-off control is active.

In the vehicle display control device 10 pertaining to the present embodiment, the ACC function in the autonomous driving mode allows the vehicle 12 to follow a perceived preceding vehicle while maintaining a following distance based on vehicle speed. Therefore, the occupant may anticipate control to accelerate/decelerate the vehicle 12 by the relative positional relationship between the preceding vehicle image M2 and the target bar M3 that are displayed on the second display unit 26.

The vehicle display control device 10 pertaining to a modification example of the present embodiment superimposes the target bar M3 on the road surface image M4 and the boundary line images M5 and displays the target bar M3 such that it extends long in the left-right direction. Therefore, the amount of visual information for allowing the occupant to understand the set following distance may be increased compared with a case where the target bar M3 is superimposed and displayed only on the road surface image M4.

In the vehicle display control device 10 pertaining to a modification example of the present embodiment, the set following distance is indicated by the position at which the preceding vehicle image M2, the road surface image M4, the boundary line images M5, and the image effects M6 greatly change. Therefore, the amount of visual information for allowing the occupant to understand the set following distance may be increased compared with a case where the set following distance is indicated only by the target bar M3.

In the vehicle display control device 10 pertaining to a modification example of the present embodiment, the set following distance is indicated by the position at which gradations in the road surface image M4 greatly change. For that reason, the set following distance is indicated by color changes that change in stages, so the occupant is unlikely to experience a sense of visual incongruity.

It will be noted that the control process that the CPU 30 executed by reading software (a program) in the above embodiment may also be executed by various types of processors other than a CPU. Examples of processors in this case include programmable logic devices (PLDs) whose circuit configuration may be changed after manufacture, such as field-programmable gate arrays (FPGAs), and dedicated electrical circuits that are processors having a circuit configuration dedicatedly designed for executing specific processes, such as application-specific integrated circuits (ASICs). Furthermore, the control process may be executed by one of these various types of processors or may be executed by a combination of two or more processors of the same type or different types (e.g., plural FPGAs, and a combination of a CPU and an FPGA, etc.). The hardware structures of these various types of processors are more specifically electrical circuits in which circuit elements such as semiconductor elements are combined.

In the above embodiment, an aspect has been described where the program is stored (installed) beforehand in the ROM 32 or the storage 36, however, the embodiment is not limited to this. The program may also be provided in a form in which it is recorded in a recording medium such as a compact disc read-only memory (CD-ROM), a digital versatile disc read-only memory (DVD-ROM), and a universal serial bus (USB) memory. The program may also take a form in which it is downloaded via a network from an external device.

What is claimed is:

1. A display control device comprising:
a memory; and
a processor coupled to the memory, the processor being configured to:
display, on a display unit provided in a vehicle, a host vehicle image representing the vehicle and a preceding vehicle image representing a preceding vehicle and arranged in accordance with a relative positional relationship between the vehicle and the preceding vehicle; and
display a first side on the display unit in a manner different from a second side on the display unit, the first side being a side of the host vehicle image with respect to a set following position that is set based on a following distance setting in a preceding vehicle following function, and the second side being an opposite side of the first side with respect to the set following position.

2. The display control device of claim 1, wherein the processor is configured to display an icon at the set following position on the display unit.

3. The display control device of claim 1, wherein the processor is configured to display on the display unit a road surface image representing a road surface on which the vehicle is driving, and display the first side in the road surface image with respect to the set following position in a manner different from the second side in the road surface image.

4. The display control device of claim 3, wherein the processor is configured to, in a case in which the preceding vehicle following function is active, display the road surface image using a color different from a color that is used in a case in which the preceding vehicle following function is not active.

5. The display control device of claim 3, wherein the processor is configured to, in a case in which the preceding vehicle following function is active, display the first side in the road surface image with respect to the set following position using a lighter color than a color of the second side in the road surface image.

6. The display control device of claim 3, wherein the processor is configured to, in a case in which the preceding vehicle following function is active, display the first side in the road surface image and the second side in the road surface image by using colors in a same family.

7. The display control device of claim 6, wherein the processor is configured to, in a case in which the preceding vehicle following function is active, use colors of families different from the colors in the same family as a color for displaying the road surface image during detection of an accelerator override function and a color for displaying the road surface image during hands-off control.

8. A display control method executed by a computer, the method comprising:
displaying, on a display unit provided in a vehicle, a host vehicle image representing the vehicle and a preceding vehicle image representing a preceding vehicle and arranged in accordance with a relative positional relationship between the vehicle and the preceding vehicle; and
displaying a first side on the display unit in a manner different from a second side on the display unit, the first side being a side of the host vehicle image with respect to a set following position that is set based on a following distance setting in a preceding vehicle following function, and the second side being an opposite side of the first side with respect to the set following position.

9. A non-transitory storage medium storing a program that causes a computer to execute a display control process, the display control process comprising:
displaying, on a display unit provided in a vehicle, a host vehicle image representing the vehicle and a preceding vehicle image representing a preceding vehicle and arranged in accordance with a relative positional relationship between the vehicle and the preceding vehicle; and
displaying a first side on the display unit in a manner different from a second side on the display unit, the first side being a side of the host vehicle image with respect to a set following position that is set based on a following distance setting in a preceding vehicle following function, and the second side being an opposite side of the first side with respect to the set following position.
